(19) United States
(12) Patent Application Publication
(10) Pub. No.: US 2019/0349757 A1
(43) Pub. Date: Nov. 14, 2019

(54) POSITION AUTHENTICATION SYSTEM, POSITIONING TERMINAL DEVICE, AND POSITION AUTHENTICATION DEVICE

(71) Applicants: Tsuneo SATO, Chiyoda-ku (JP); Mitsunobu YOSHIDA, Chiyoda-ku (JP)

(72) Inventors: Tsuneo SATO, Chiyoda-ku (JP); Mitsunobu YOSHIDA, Chiyoda-ku (JP)

(21) Appl. No.: 16/478,962

(22) PCT Filed: Mar. 6, 2018
(86) PCT No.: PCT/JP2018/008501

§ 371 Date: Jul. 18, 2019

(30) Foreign Application Priority Data
Mar. 9, 2017 (JP) 2017-045430

(51) Int. Cl. H04W 12/00; H04W 12/06; H04L 29/06; H04B 7/185; H04L 9/08; G01S 19/28; H04W 4/029

(52) U.S. Cl. CPC H04W 12/00503; H04W 12/06; H04L 63/12; H04W 4/029; H04L 9/0872; G01S 19/28; H04B 7/18547; H04B 7/18513

(57) ABSTRACT

A positioning terminal transmits terminal position information to a position authentication device. The position authentication device acquires a digitized positioning signal and a positioning augmentation signal as the same data as data used by the positioning terminal device to calculate a positioning position and a positioning time included in the terminal position information. The position authentication device calculates a corresponding position corresponding to the positioning position included in the terminal position information and a corresponding time corresponding to the positioning time included in the terminal position information, based on the acquired digitized positioning signal and positioning augmentation signal, and compares the corresponding position with the positioning position and compares the corresponding time with the positioning time.

### TECHNICAL FIELD

The present invention relates to a terminal that notifies a reception position, a method for authenticating the notified reception position, and an authentication device in a system in which a positioning signal from a satellite is received, a reception position is calculated based on the positioning signal, and the reception position is notified to a center station.

### BACKGROUND ART

A conventional “mutual authentication system and mutual authentication method using a GPS function” discloses a mutual authentication system of an authentication device and a mobile terminal.

The mobile terminal has a position information authentication function unit that performs authentication of a position of the authentication device based on pre-stored position information of the authentication device. The authentication device has a position information authentication function unit that performs authentication of a position of the mobile terminal based on position information from the mobile terminal and permitted position information of the mobile terminal pre-stored in a mobile terminal database. The authentication device extracts permitted position information from the mobile terminal database, using an individual device number of the mobile terminal received from the mobile terminal as a key, and performs authentication of the mobile terminal based on this permitted position information and the received terminal position information. The mobile terminal performs authentication of the authentication device based on position information from the authentication device and the pre-stored position information of the authentication device. In this way, mutual authentication is realized (for example, Patent Literature 1).

### CITATION LIST

### Patent Literature

Patent Literature 1: JP 2014-2572 A

### SUMMARY OF INVENTION

### Technical Problem

In the conventional “mutual authentication system and mutual authentication method using the GPS function”, a problem is that if the mobile terminal transmits fake position information that matches the permitted position information of the mobile terminal pre-stored in the authentication device, that is, if a position where the mobile terminal does not exist is fabricated, the authentication device cannot detect fabrication of the position of the mobile terminal.

It is an object of the present invention to provide a position authentication system that determines fabrication of a position of a mobile terminal.

### Solution to Problem

A position authentication system according to the present invention includes a positioning terminal device and a position authentication device.

The positioning terminal device receives, from a positioning satellite that transmits a positioning signal, the positioning signal and calculates a positioning position which indicates a reception position of the positioning signal and a positioning time which indicates a time when the positioning terminal device exists at the positioning position, based on the received positioning signal, and transmits terminal position information including the positioning position, the positioning time, and identification information for identifying the positioning terminal device to the position authentication device, and

transmits a digitized positioning signal which is obtained by digitizing the positioning signal to the position authentication device, and

the position authentication device calculates a corresponding position corresponding to the positioning position and a corresponding time corresponding to the positioning time, based on the digitized positioning signal transmitted from the positioning terminal device, and compares the corresponding position with the positioning position and compares the corresponding time with the positioning time.

### Advantageous Effects of Invention

According to the present invention, a position authentication system that determines fabrication of a position of a mobile terminal can be provided.

### BRIEF DESCRIPTION OF DRAWINGS

FIG. 1 is a diagram of a first embodiment and is a system configuration diagram of a typical position authentication system 9;

FIG. 2 is a diagram of the first embodiment and is a diagram illustrating a configuration of a position authentication system 1001;

FIG. 3 is a diagram of the first embodiment and is an explanatory diagram of a positioning method using a positioning augmentation signal in the position authentication system 1001;

FIG. 4 is a diagram of the first embodiment and is a diagram that describes a position authentication method in the position authentication system 1001;

FIG. 5 is a diagram of the first embodiment and is an explanatory diagram of Cases 2 and 3 of position/time fabrication without receiving a positioning signal;

FIG. 6 is a diagram of the first embodiment and is an explanatory diagram of Case 5 of position/time fabrication using a correct position/time using a positioning satellite;

FIG. 7 is a diagram of the first embodiment and is a configuration diagram of a positioning terminal 2;

FIG. 8 is a diagram of the first embodiment and is a configuration diagram of a positioning augmentation signal generator 4;

FIG. 9 is a diagram of the first embodiment and is a configuration diagram of a position authentication device 5;

FIG. 10 is a diagram of the first embodiment and is a sequence diagram that describes the first half of the position authentication method in the position authentication system 1001;

FIG. 11 is a diagram of the first embodiment and is a sequence diagram that describes the second half of the position authentication method in the position authentication system 1001;

FIG. 12 is a diagram of a second embodiment and is an explanatory diagram of a high-accuracy position/time measurement method in a position authentication system 1002;

FIG. 13 is a diagram of the second embodiment and is an explanatory diagram of a high-accuracy position authentication method in the position authentication system 1002;

FIG. 14 is a diagram of the second embodiment and is an explanatory diagram of Case 2 of position/time fabrication without receiving a positioning signal and a quasi-zenith augmentation signal;

FIG. 15 is a diagram of the second embodiment and is an explanatory diagram of Case 4 of position/time fabrication using a correct position/time using a quasi-zenith satellite 8; and

FIG. 16 is a diagram of the second embodiment and is a sequence diagram that describes a position authentication method in the position authentication system 1002.

### DESCRIPTION OF EMBODIMENTS

### First Embodiment

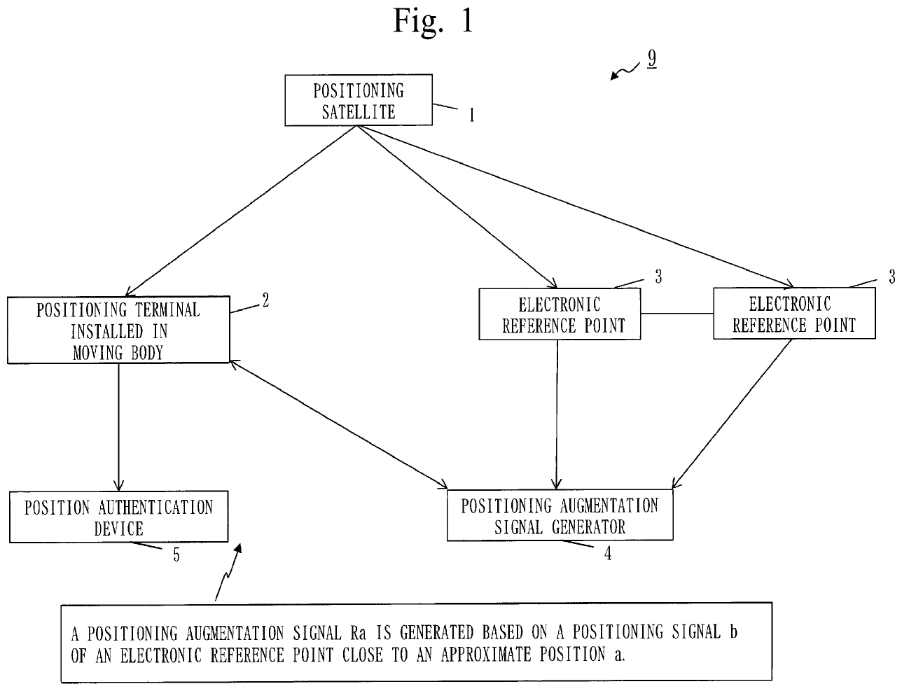

A position authentication system 1001 of a first embodiment will be described with reference to FIGS. 1 to 11.

FIG. 1 is a system configuration diagram of a typical position authentication system 9.

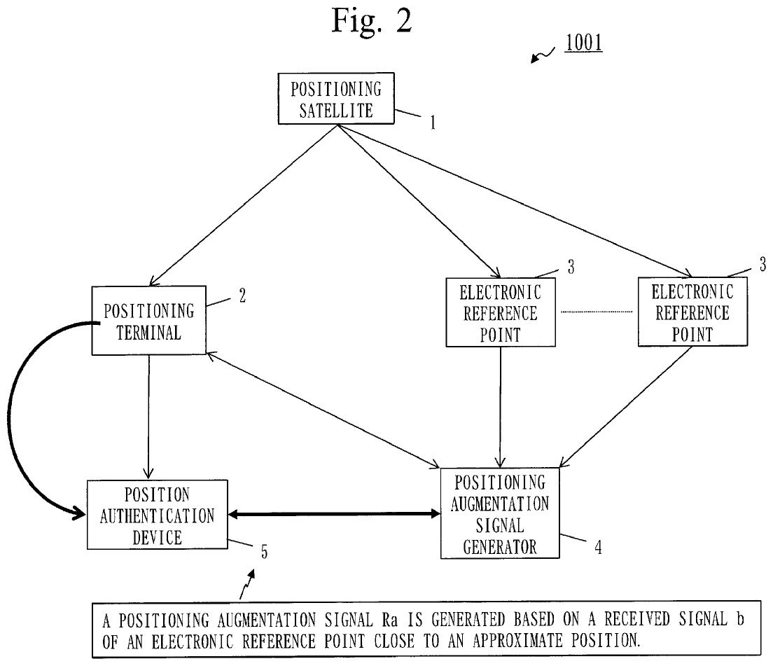

FIG. 2 is a diagram illustrating a configuration of the position authentication system 1001.

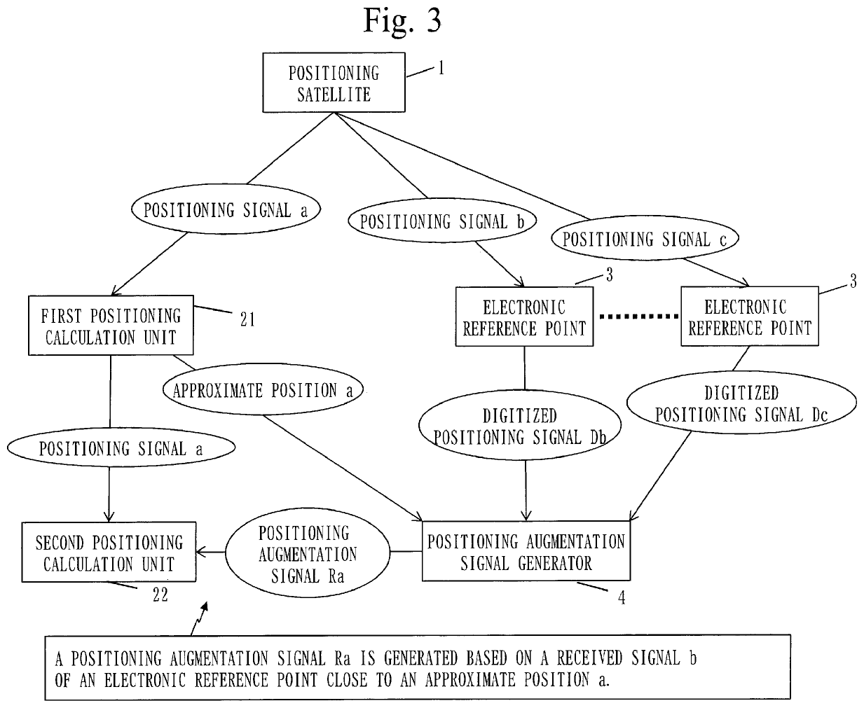

FIG. 3 is an explanatory diagram of a positioning method using a positioning augmentation signal in the position authentication system 1001.

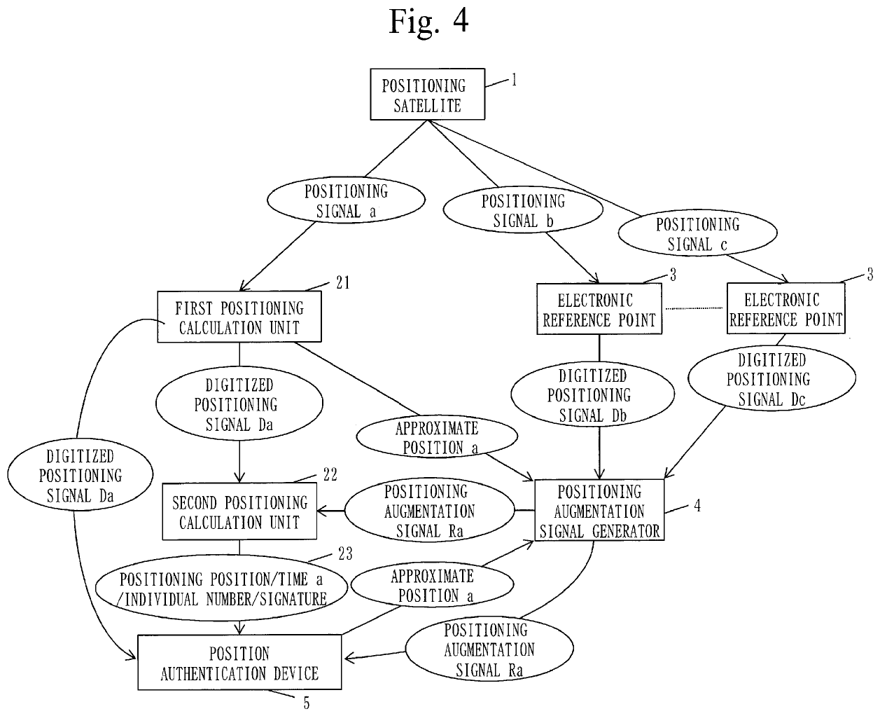

FIG. 4 is a diagram that describes a position authentication method in the position authentication system 1001.

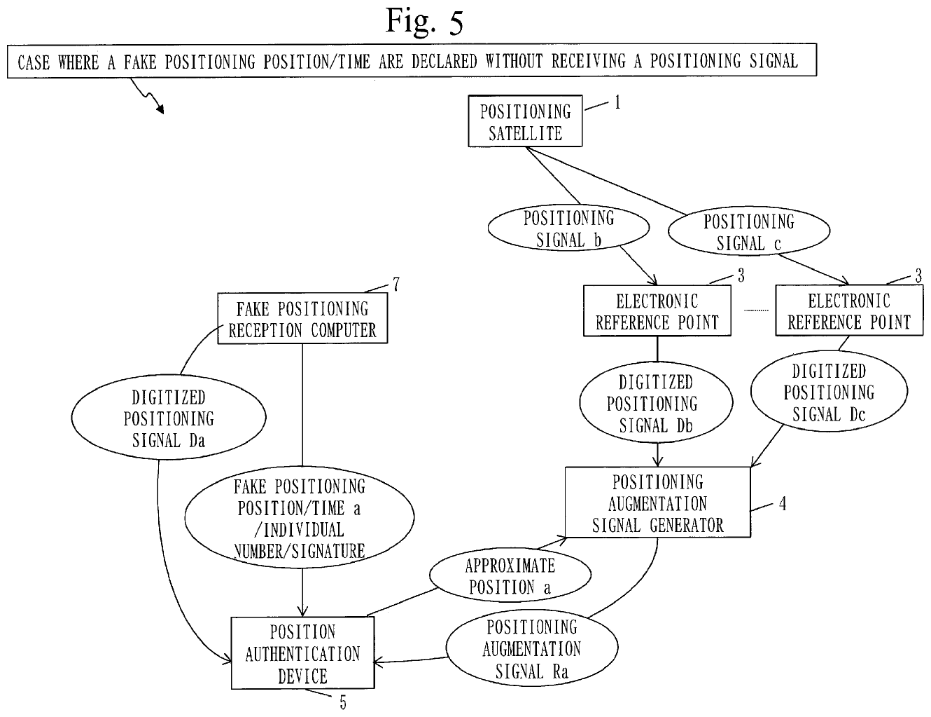

FIG. 5 is an explanatory diagram of Case 2 and Case 3 to be described later.

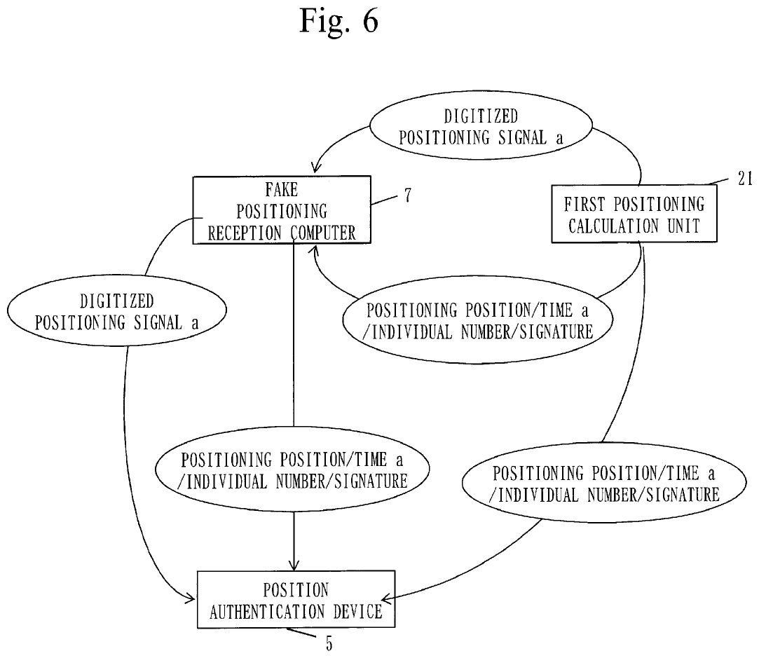

FIG. 6 is an explanatory diagram of Case 5 to be described later.

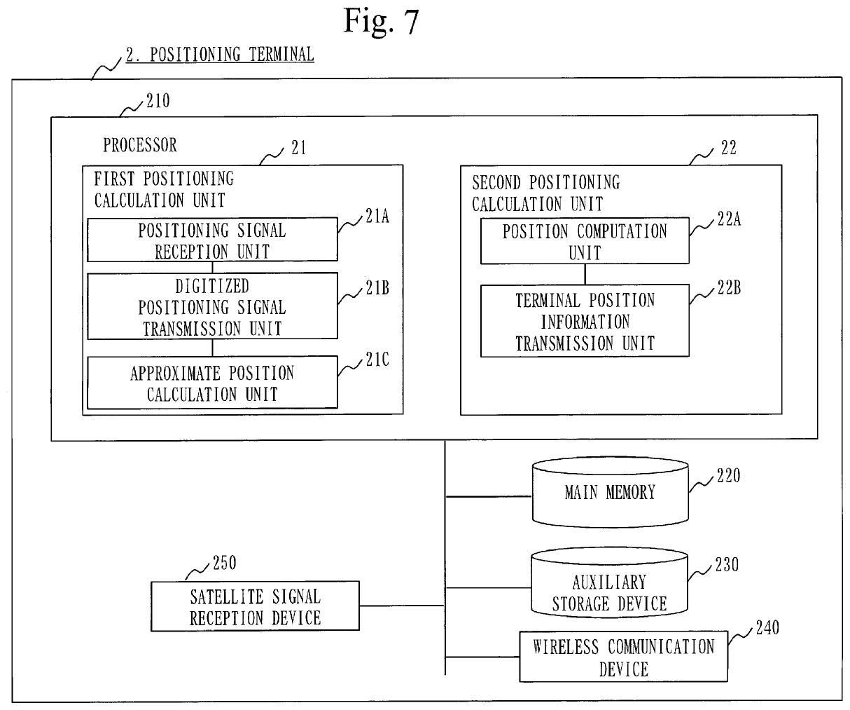

FIG. 7 is a configuration diagram of a positioning terminal 2.

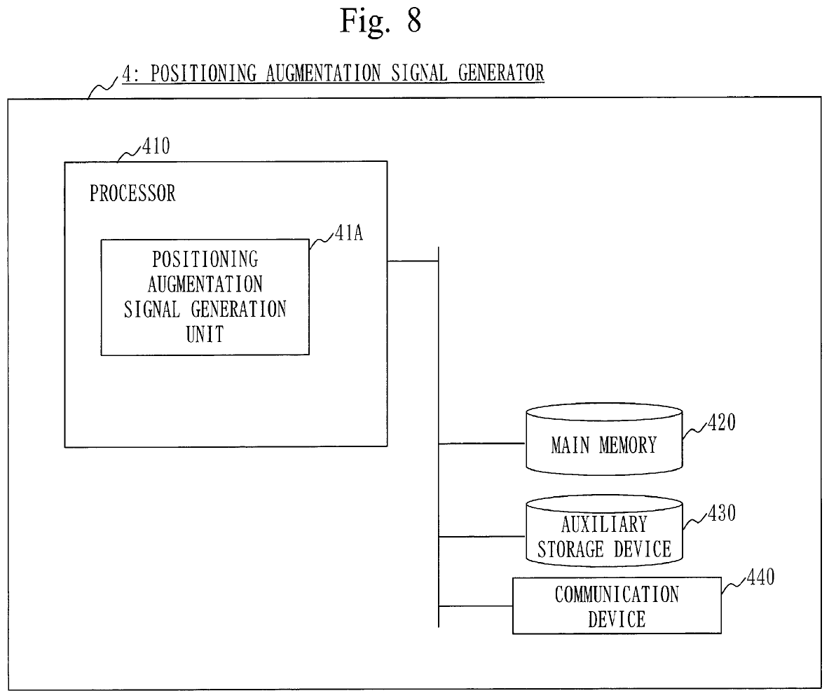

FIG. 8 is a configuration diagram of a positioning augmentation signal generator 4.

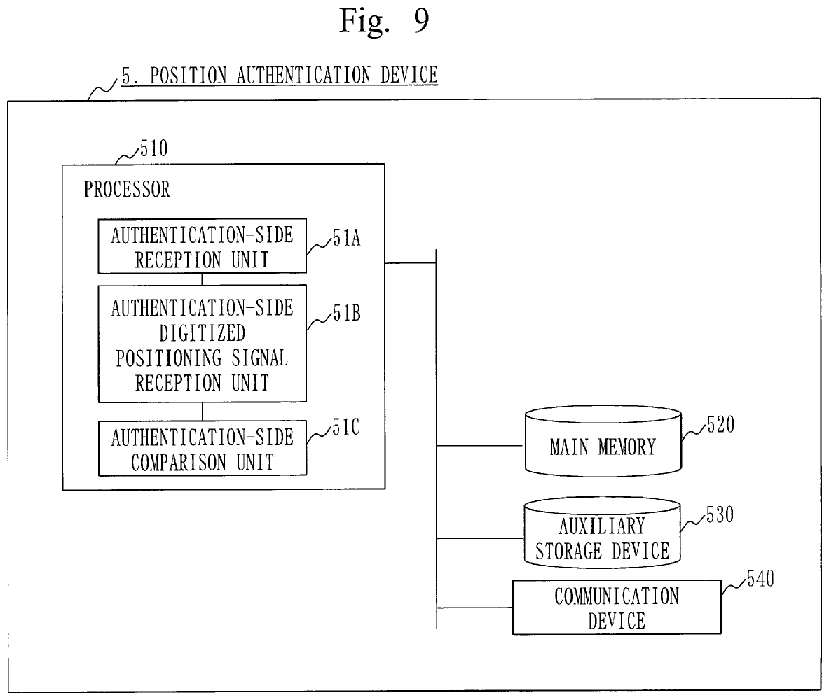

FIG. 9 is a configuration diagram of a position authentication device 5.

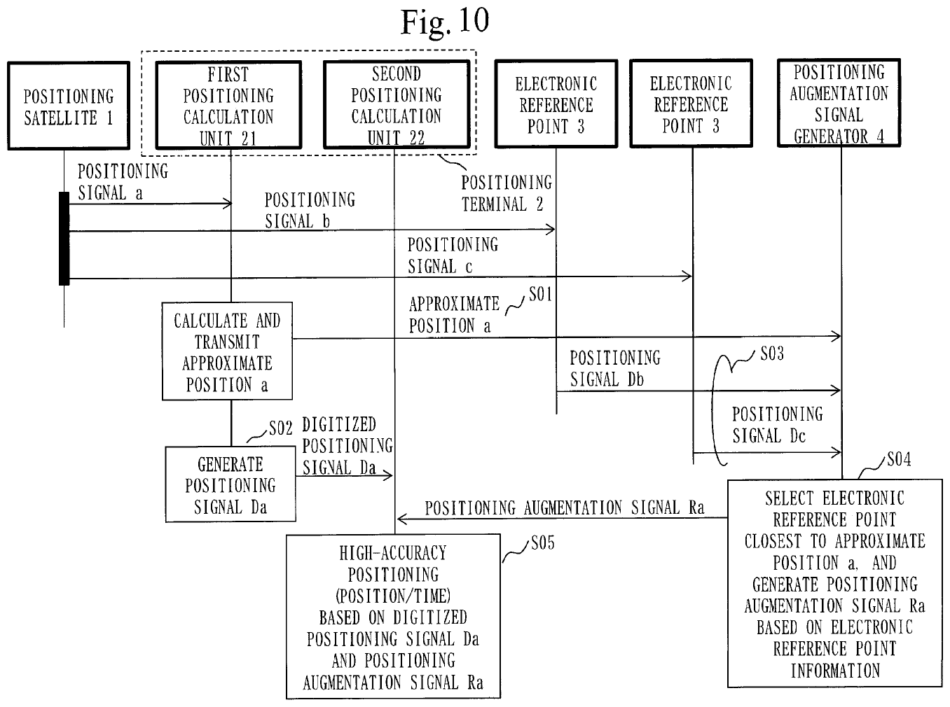

FIG. 10 is a sequence diagram that describes the first half of the position authentication method in the position authentication system 1001.

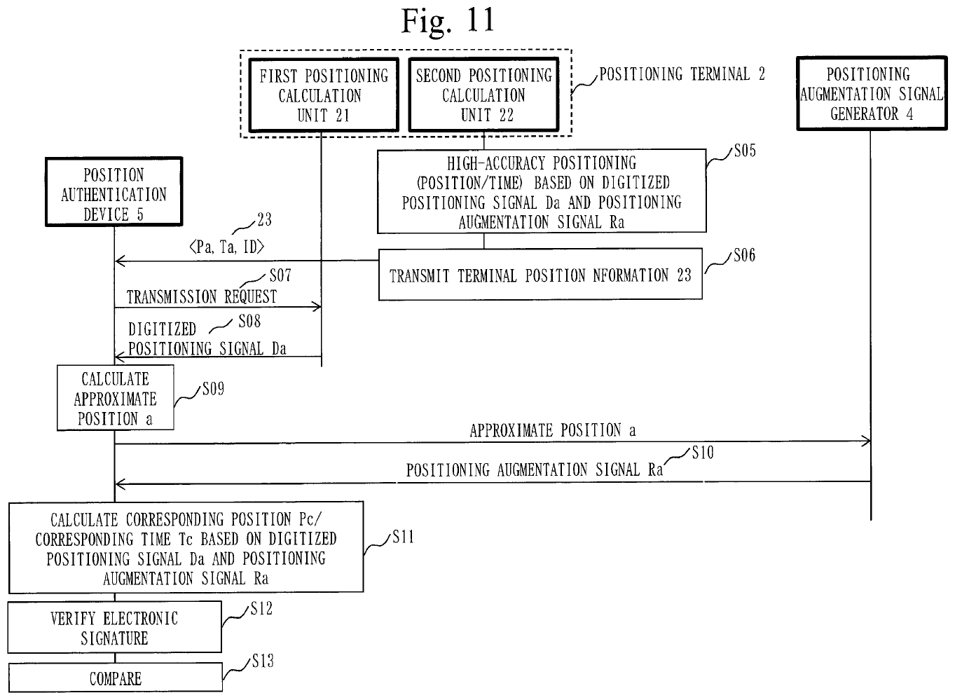

FIG. 11 is a sequence diagram that describes the second half of the position authentication method in the position authentication system 1001.

The typical position authentication system 9 of FIG. 1 is used for comparison with the position authentication system 1001. The position authentication system 9 includes a positioning satellite 1, a positioning terminal device 2, electronic reference points 3, a positioning augmentation signal generator 4, and a position authentication device 5. The positioning satellite 1 sends out a positioning signal. The positioning terminal device 2 is installed in a moving body such as a vehicle, and uses the positioning signal to measure a positioning position, which is a position of the positioning terminal device 2, and a positioning time thereof. The positioning time is a time when the positioning terminal device 2 exists at that positioning position. In the following, the positioning terminal device 2 will be referred to as the positioning terminal 2. The positioning terminal 2 can measure a positioning position and a positioning time with higher accuracy by using a positioning augmentation signal R to be described later. The electronic reference points 3 are located at various places to receive a positioning signal and transmit the positioning signal to the positioning augmentation signal generator 4. The positioning augmentation signal generator 4 uses the positioning signal from each of the electronic reference points 3 to generate a positioning augmentation signal R appropriate for an approximate position of the positioning terminal 2. The position authentication device 5 is a position authentication device that authenticates a position/time notified from the positioning terminal 2. Note that the notation “position/time” means “position and time”.

As illustrated in FIG. 2, the position authentication system 1001 includes a positioning satellite 1, the positioning terminal 2, electronic reference points 3, the positioning augmentation signal generator 4, and the position authentication device 5, as with the typical position authentication system 9. The position authentication system 1001 differs from the position authentication system 9 in the following points (1) and (2).

(1) The position authentication device 5 and the positioning augmentation signal generator 4 communicate with each other, and

(2) the position authentication device 5 receives a digitized positioning signal as well as a position/time from the positioning terminal 2.

Note that a positioning scheme in the position authentication system 1001 is assumed to be Real Time Kinematic Global Positioning System (RTK-GPS) or network RTK.

***Description of Configuration***

A configuration of the positioning terminal 2 of the first embodiment will be described with reference to FIG. 7. The positioning terminal 2 is a computer. The positioning terminal 2 has hardware, such as a processor 210, a main memory 220, an auxiliary storage device 230, a wireless communication device 240, and a satellite signal reception device 250. The processor 210 is connected with other hardware components via signal lines, and controls these other hardware components.

The processor 210 is an integrated circuit (IC) that performs arithmetic processing. As a specific example, the processor 210 is a central processing unit (CPU), a digital signal processor (DSP), or a graphics processing unit (GPU).

Note that the processor 210, and a processor 410 and a processor 510 of FIG. 8 and FIG. 9, respectively, are also referred to as processing circuitry.

The main memory 220 is a readable and writable volatile storage device. As a specific example, the main memory 220 is a static random access memory (SRAM) or a dynamic random access memory (DRAM).

The auxiliary storage device 230 is a readable and writable nonvolatile storage device. The auxiliary storage device 230 stores programs for realizing the functions of the positioning terminal 2. As a specific example, the auxiliary storage device 230 is a magnetic disk drive (hard disk drive). Alternatively, the auxiliary storage device 230 may be a storage device using a portable storage medium, such as an optical disc, a compact disc, a Blu-ray (registered trademark) disc, or a digital versatile disc (DVD).

The wireless communication device 240 is a device that performs wireless communication by Dedicated Short Range Communications (DSRC) with a roadside device, for example. The wireless communication device 240 communicates with the positioning augmentation signal generator 4, the position authentication device 5, and the like via the roadside device.

The satellite signal reception device 250 is a device that receives a signal transmitted by the positioning satellite 1 or a quasi-zenith satellite 8.

The positioning terminal 2 has, as functional components, a positioning signal reception unit 21A, a digitized positioning signal transmission unit 21B, and an approximate position calculation unit 21C. The positioning signal reception unit 21A, the digitized positioning signal transmission unit 21B, and the approximate position calculation unit 21C constitute a first positioning calculation unit 21. The positioning terminal 2 also has, as functional components, a position computation unit 22A and a terminal position information transmission unit 22B. The position computation unit 22A and the terminal position information transmission unit 22B constitute a second positioning calculation unit 22. The functions of the positioning signal reception unit 21A, the digitized positioning signal transmission unit 21B, the approximate position calculation unit 21C, the position computation unit 22A, and the terminal position information transmission unit 22B are realized by software. The auxiliary storage device 230 stores the programs for realizing the functions of the positioning signal reception unit 21A, the digitized positioning signal transmission unit 21B, the approximate position calculation unit 21C, the position computation unit 22A, and the terminal position information transmission unit 22B. These programs are read and executed by the processor 210. In this way, the functions of the positioning signal reception unit 21A, the digitized positioning signal transmission unit 21B, the approximate position calculation unit 21C, the position computation unit 22A, and the terminal position information transmission unit 22B are realized.

The programs for realizing the functions of the positioning signal reception unit 21A, the digitized positioning signal transmission unit 21B, the approximate position calculation unit 21C, the position computation unit 22A, and the terminal position information transmission unit 22B may be provided as being stored on a computer readable recording medium or may be provided as a program product.

In FIG. 7, only one processor 210 is illustrated. However, the positioning terminal 2 may have a plurality of processors as an alternative to the processor 210. These processors share execution of the programs of the positioning signal reception unit 21A, the digitized positioning signal transmission unit 21B, the approximate position calculation unit 21C, the position computation unit 22A, and the terminal position information transmission unit 22B. Each of the processors is an IC that performs arithmetic processing, as with the processor 210.

A configuration of the positioning augmentation signal generator 4 will be described with reference to FIG. 8. The positioning augmentation signal generator 4 is also a computer. The positioning augmentation signal generator 4 has hardware, such as the processor 410, a main memory 420, an auxiliary storage device 430, and a communication device 440. The processor 410 is connected with other hardware components via signal lines, and controls these other hardware components.

The processor 410, the main memory 420, and the auxiliary storage device 430 are substantially the same as the processor 210, the main memory 220, and the auxiliary storage device 230 of the positioning terminal 2. The auxiliary storage device 430 stores a program for realizing the function of the positioning augmentation signal generator 4.

The communication device 440 is a device that communicates with the positioning terminal 2, the electronic reference points 3, the position authentication device 5, and the like.

The positioning augmentation signal generator 4 has, as a functional component, a positioning augmentation signal generation unit 41A. The function of the positioning augmentation signal generation unit 41A is realized by software. The auxiliary storage device 430 stores the program for realizing the function of the positioning augmentation signal generation unit 41A. This program is read and executed by the processor 410. In this way, the function of the positioning augmentation signal generation unit 41A is realized.

The program for realizing the function of the positioning augmentation signal generation unit 41A may be provided as being stored on a computer readable recording medium, or may be provided as a program product.

A configuration of the position authentication device 5 will be described with reference to FIG. 9. The position authentication device 5 is also a computer. The positioning augmentation signal generator 4 has hardware, such as the processor 510, a main memory 520, an auxiliary storage device 530, and a communication device 540. The processor 510 is connected with other hardware components via signal lines, and controls these other hardware components.

The processor 510, the main memory 520, and the auxiliary storage device 530 are substantially the same as the processor 210, the main memory 220, and the auxiliary storage device 230 of the positioning terminal 2. The auxiliary storage device 530 stores programs for realizing the functions of the position authentication device 5.

The communication device 540 is a device that communicates with the positioning terminal 2, the positioning augmentation signal generator 4, and the like.

The position authentication device 5 has, as functional components, an authentication-side reception unit 51A, an authentication-side digitized positioning signal reception unit 51B, and an authentication-side comparison unit 51C. The functions of the authentication-side reception unit 51A, the authentication-side digitized positioning signal reception unit 51B, and the authentication-side comparison unit 51C are realized by software. The auxiliary storage device 530 stores the programs for realizing the functions of the authentication-side reception unit 51A, the authentication-side digitized positioning signal reception unit 51B, and the authentication-side comparison unit 51C. These programs are read and executed by the processor 510. In this way, the functions of the authentication-side reception unit 51A, the authentication-side digitized positioning signal reception unit 51B, and the authentication-side comparison unit 51C are realized.

The programs for realizing the functions of the authentication-side reception unit 51A, the authentication-side digitized positioning signal reception unit 51B, and the authentication-side comparison unit 51C may be provided as being stored on a computer readable recording medium, or may be provided as a program product.

***Description of Operation***

The operation of the position authentication system 1001 will now be described with reference to FIGS. 3, 4, 10, and 11.

In the following description, the positioning terminal 2 will be described by being divided into the first positioning calculation unit 21 that calculates a position/time based on a positioning signal, and the second positioning calculation unit 22 that calculates a high-accuracy position/time based on a positioning signal and a positioning augmentation signal. Ellipses represent information to be exchanged.

A high-accuracy position/time measurement method using a positioning augmentation signal will be described with reference to FIG. 3. The positioning satellite 1 sends out a positioning signal. The positioning signal sent out from the positioning satellite 1 is of a single type. However, depending on the position where this signal is received, the received positioning signal varies. In FIG. 3, the positioning signal received by the positioning signal reception unit 21A of the first positioning calculation unit 21 using the satellite signal reception device 250 is denoted as a positioning signal a, and the positioning signals received by the electronic reference points 3 located at different places are denoted as positioning signals b and c. Note that FIG. 3 illustrates that each of the first positioning calculation unit 21 and the electronic reference points 3 receives a positioning signal from one positioning satellite 1. In reality, however, positioning signals from a plurality of positioning satellites 1 are received to perform positioning or generate a positioning augmentation signal.

When the positioning signal reception unit 21A receives the positioning signal a using the satellite signal reception device 250, the approximate position calculation unit 21C of the first positioning calculation unit 21 analyzes the positioning signal a to calculate an approximate position a (step S01). The approximate position a refers to a position which is calculated without using a positioning augmentation signal. The approximate position calculation unit 21C uses the wireless communication device 240 to transmit the approximate position a to the positioning augmentation signal generator 4. The digitized positioning signal transmission unit 21B digitizes the positioning signal a received by the positioning signal reception unit 21A of the first positioning calculation unit 21 using the satellite signal reception device 250 so as to generate a digitized positioning signal Da, and transmits the digitized positioning signal Da to the second positioning calculation unit 22 (step S02).

Each of the electronic reference points 3 digitizes the received positioning signal b or positioning signal c to generate a digitized positioning signal Db or Dc, and transmits the digitized positioning signal Db or Dc to the positioning augmentation signal generator 4 (step S03). The positioning augmentation signal generator 4 generates a positioning augmentation signal Ra based on the digitized positioning signal of one of the electronic reference points 3 close in distance to the approximate position a, and transmits the positioning augmentation signal Ra to the second positioning calculation unit 22 (step S04).

In the second positioning calculation unit 22, the position computation unit 22A uses the wireless communication device 240 to receive the positioning augmentation signal Ra, and the position computation unit 22A uses the positioning signal a and the positioning augmentation signal Ra to calculate a positioning position Pa which indicates a reception position of the positioning signal a and a positioning time Ta which indicates a time when the positioning terminal 2 exists at the positioning position Pa (step S05). In this way, the positioning terminal 2 calculates the positioning position Pa and the positioning time Ta, based on the positioning augmentation signal Ra for correcting a calculation error of the positioning position Pa in addition to the positioning signal a.

The position authentication method of the first embodiment will be described with reference to FIGS. 4 and 11. Up to step S05 where a high-accuracy positioning position and a high-accuracy positioning time are calculated in the second positioning calculation unit 22 is substantially the same as in FIGS. 3 and 10.

The terminal position information transmission unit 22B of the second positioning calculation unit 22 uses the wireless communication device 240 to transmit to the position authentication device 5 terminal position information 23 including the positioning position Pa and the positioning time Ta calculated by the position computation unit 22A and a terminal ID which is identification information for identifying the positioning terminal 2 (step S06). In this case, the terminal position information transmission unit 22B applies an electronic signature to the terminal position information 23 with secret information that only the second positioning calculation unit 22 has, and transmits the terminal position information 23 together with the electronic signature to the position authentication device 5. The secret information is, for example, a secret key in a public key encryption scheme. The secret key is stored in the auxiliary storage device 230.

The positioning terminal 2 receives the positioning signal a from the positioning satellite 1 that transmits positioning signals, and based on the positioning signal a, calculates a positioning position Pa which indicates a reception position of the positioning signal a.

The authentication-side reception unit 51A receives from the positioning terminal 2 the terminal position information 23 including the positioning position Pa, the positioning time Ta which indicates the time when the positioning terminal 2 exists at the positioning position Pa, and the terminal ID which is identification information (individual number) for identifying the positioning terminal 2.

The authentication-side digitized positioning signal reception unit 51B of the position authentication device 5 instructs the first positioning calculation unit 21 to transmit the digitized positioning signal Da, using a communication channel not illustrated and via the communication device 540 (step S07). The digitized positioning signal transmission unit 21B of the first positioning calculation unit 21 receives a transmission request via the wireless communication device 240, and transmits the digitized positioning signal Da to the position authentication device 5 via the wireless communication device 240 (step S08). The authentication-side digitized positioning signal reception unit 51B receives the digitized positioning signal Da, which is obtained by digitizing the positioning signal a by the positioning terminal 2, from the positioning terminal 2 via the communication device 540. Note that when the transmission request for the digitized positioning signal Da is not transmitted from the position authentication device 5, and the terminal position information 23 is transmitted from the positioning terminal 2 to the position authentication device 5, the positioning terminal 2 may be configured to also transmit the digitized positioning signal Da.

In the position authentication device 5, the authentication-side comparison unit 51C uses the digitized positioning signal Da to calculate an approximate position a, and transmits the approximate position a to the positioning augmentation signal generator 4 via the communication device 540 (step S09). In the positioning augmentation signal generator 4, the positioning augmentation signal generation unit 41A receives the approximate position a via the communication device 440. The positioning augmentation signal generation unit 41A generates a positioning augmentation signal Ra corresponding to the approximate position a, based on a digitized positioning signal acquired from one of the electronic reference points 3, and transmits the positioning augmentation signal Ra back to the position authentication device 5 via the communication device 440 (step S10). In the position authentication device 5, the authentication-side comparison unit 51C calculates a positioning position Pa and a positioning time Ta of the positioning terminal 2 based on the digitized positioning signal Da and the positioning augmentation signal Ra (step S11). The positioning position Pa and the positioning time Ta calculated by the authentication-side comparison unit 51C will be referred to as a corresponding position Pc and a corresponding time Tc, respectively. In this way, the authentication-side comparison unit 51C acquires the positioning augmentation signal Ra, and calculates the corresponding position Pc and the corresponding time Tc based on the acquired positioning augmentation signal Ra in addition to the digitized positioning signal Da.

Upon receiving the terminal position information 23 to which the electronic signature has been applied, the position authentication device 5 verifies the electronic signature. That is, in the position authentication device 5, the authentication-side comparison unit 51C verifies the electronic signature appended to the terminal position information 23 transmitted from the second positioning calculation unit 22 (step S12). If the verification is successful, the authentication-side comparison unit 51C authenticates that the terminal position information 23 is authentic and is the terminal position information 23 transmitted from the second positioning calculation unit 22 (positioning terminal 2) having the terminal ID (individual number). If the verification is unsuccessful, the authentication-side comparison unit 51C determines that the transmitted data is fraudulent.

Further, in the position authentication device 5, the authentication-side comparison unit 51C compares the positioning position Pa and the positioning time Ta included in the terminal position information 23 transmitted from the second positioning calculation unit 22 with the corresponding position Pc and the corresponding time Tc calculated by the authentication-side comparison unit 51C itself (step S13). The authentication-side comparison unit 51C compares the positioning position Pa with the corresponding position Pc, and compares the positioning time Ta with the corresponding time Tc. The authentication-side comparison unit 51C calculates the corresponding position Pc corresponding to the positioning position Pa and the corresponding time Tc corresponding to the positioning time Ta, based on the digitized positioning signal Da, and compares the corresponding position Pc with the positioning position Pa and compares the corresponding time Tc with the positioning time Ta (step S13). If a difference between the positions and a difference between the times are less than or equal to a threshold for the difference between positions and a threshold for the difference between times, respectively, the authentication-side comparison unit 51C authenticates that the second positioning calculation unit 22 (positioning terminal 2) that transmits the terminal position information 23 is an authentic device. If the difference between the positioning positions or the positioning times exceeds the threshold, the authentication-side comparison unit 51C deems the second positioning calculation unit 22 (positioning terminal 2) that transmits the terminal position information 23 as fraudulent. For example, the threshold for the difference between positioning positions is assumed to be several centimeters.

As described above, the authentication-side comparison unit 51C calculates the corresponding position Pc corresponding to the positioning position Pa and the corresponding time Tc corresponding to the positioning time Ta, based on the digitized positioning signal Da, and compares the corresponding position Pc with the positioning position Pa and compares the corresponding time Tc with the positioning time Ta.

Next, the reason why the position authentication system 1001 of the first embodiment enables position authentication will be described. In the case of RTK-GPS, it is known that a large error occurs in the positioning result unless the distance from a reference station to a reception device is less than or equal to 10 Km. The network RTK is an improvement on this point, such that virtual reference points are created using a plurality of reference stations (electronic reference points) to perform positioning calculations. This is to improve accuracy by using a positioning augmentation signal. In either of the positioning schemes, high-accuracy position and time information can be obtained by performing positioning calculations using an appropriate reference station (electronic reference point) and an appropriate positioning augmentation signal. This embodiment utilizes this feature, and utilizes the fact that when an inappropriate reference station or an inappropriate positioning augmentation signal is used, this results in a positioning result including a large error.

When a position/time are fabricated, methods of Case 1 to Case 5 as described below may be considered. The position/time indicate a positioning position and a time when the positioning terminal exists at the positioning position.

Case 1. A position/time are fabricated without using a positioning signal.
Case 2. Only position/time information is fabricated using a positioning signal previously used.
Case 3. Only position/time information is fabricated using a positioning augmentation signal previously used.
Case 4. Only position/time information is fabricated, although a correct positioning signal and a correct positioning augmentation signal are used.
Case 5. A first positioning terminal transfers position/time information calculated using a correct positioning signal and a correct positioning augmentation signal to a second positioning terminal. The second positioning terminal transmits to the position authentication device 5 the transferred position/time information from another location different from the location of the first positioning terminal, thereby fabricating the position/time information of the second positioning terminal.

<Case 1>

Since a positioning signal is not used, it is not possible to respond to the transmission request for the digitized positioning signal Da that has been digitized from the position authentication device 5 (step S07). Therefore, the position/time and the positioning measurement device (positioning terminal) in this case are eliminated as fraudulent.

<Case 2>

Case 2 will be described with reference to FIG. 5. A positioning signal used previously is transmitted from a fake positioning reception computer 7. In this case, the position authentication device 5 calculates an approximate position a, and acquires a positioning augmentation signal Ra from the positioning augmentation signal generator 4, so as to calculate a position/time of the positioning measurement device. In Case 2, only the position/time (terminal position information 23) are fabricated, as illustrated in FIG. 5. This fabricated information is different from the position/time calculated by the position authentication device 5. As a result, the fake positioning position/time and the fake positioning reception computer 7 in this case are eliminated as fraudulent.

<Case 3>

Case 3 will be described also with reference to FIG. 5. The fake positioning reception computer 7 performs positioning computations without acquiring a positioning augmentation signal Ra from the positioning augmentation signal generator 4 so as to calculate a fake positioning position/time, and transmits the fake positioning position/time to the position authentication device 5. The position authentication device 5 calculates an approximate position a based on a correct digitized positioning signal Da, and acquires a positioning augmentation signal Ra from the positioning augmentation signal generator 4 to calculate a position/time of the positioning measurement device. Since the positioning augmentation signals are different, there is a large difference between the fake positioning position/time and the position/time of the moving body terminal calculated by the position authentication device 5. Therefore, the position/time information and the moving body terminal in this case are eliminated as fraudulent.

<Case 4>

In Case 4, the position authentication device 5 uses a correct digitized positioning signal Da and a correct positioning augmentation signal Ra to calculate a position/time of the moving body terminal. This is different from fabricated position/time information. Therefore, the position/time information and the moving body terminal in this case are eliminated as fraudulent.

<Case 5>

Case 5 will be described with reference to FIG. 6. In this Case 5, correct positioning information (terminal position information 23) and a correct digitized positioning signal Da that have been transferred are transmitted from the fake positioning reception computer 7 (second positioning terminal) which is a fabrication device. The correct positioning information (terminal position information 23) and the correct digitized positioning signal Da which are the sources of the transferred ones are transmitted from the authentic device (first positioning terminal having the first positioning calculation unit 21). In this case, there are a plurality of existences of the moving body terminal that should be unique. Therefore, both are eliminated as fraudulent devices.

### Effects of First Embodiment

As described above, the position authentication device calculates the position and time of the positioning terminal 2 based on the digitized positioning signal Da that has been digitized, and compares the calculated position and time with the position and time acquired from an external device. Therefore, the position authentication device 5 checks the integrity of the digitized positioning signal Da, the positioning augmentation signal Ra, the position, the time, and the like. As a result, this has the effect of eliminating a position and a time that are fraudulent.

The position authentication device 5 verifies the signature of the terminal position information 23. Therefore, in a case of fabrication where a correct positioning position/time/individual number and a correct digitized positioning signal Da are transferred and relayed, there are a plurality of existences of the valid positioning position/time/individual number, so that there are a plurality of existences of the positioning device that is unique. In this case, the verification of the electronic signature described above has the effect of eliminating a fraudulent positioning position/time that appear to be valid.

Further, a signature is appended to a positioning position/time/individual number, and the position authentication device 5 verifies the electronic signature, so that the authentication and nonrepudiation of a transmission source are provided. This has the effect of eliminating a fraudulent device.

In the first embodiment, it has been described that the authentication process is performed each time a positioning position/time/individual number (terminal position information) are received. However, the authentication process may be performed at appropriate intervals.

Alternatively, the authentication process may be performed when the same positioning position/time/individual number are received a plurality of times.

### Second Embodiment

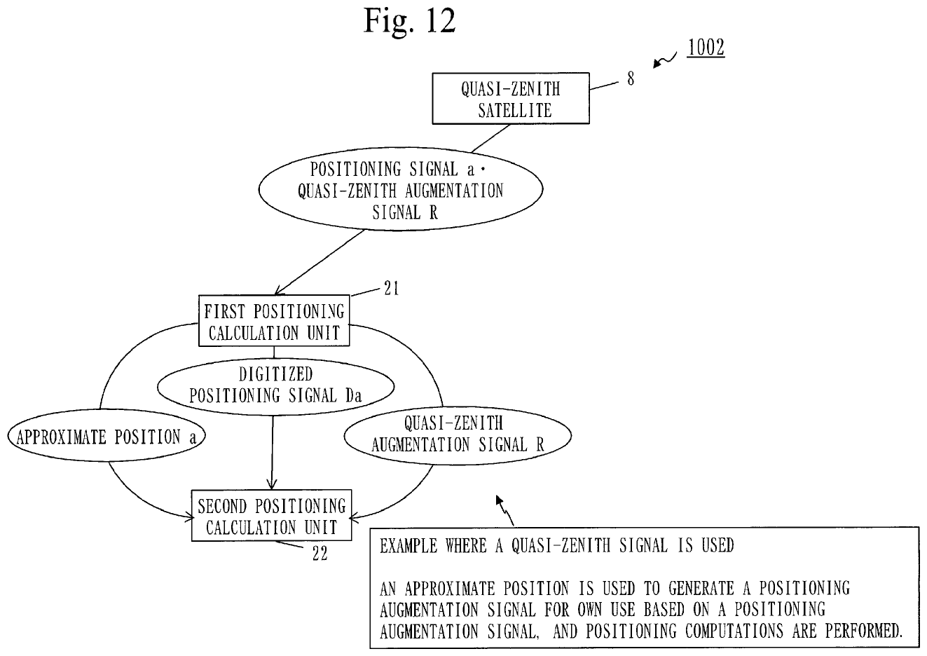

A second embodiment will be described with reference to FIGS. 12 to 16. Note that in the second embodiment, the same or corresponding parts as those of the first embodiment are denoted by the same reference signs. In the description of the second embodiment, description of the same or corresponding parts as those of the first embodiment will be omitted or simplified as appropriate.

FIG. 12 is an explanatory diagram of a high-accuracy position/time measurement method in a position authentication system 1002 of the second embodiment.

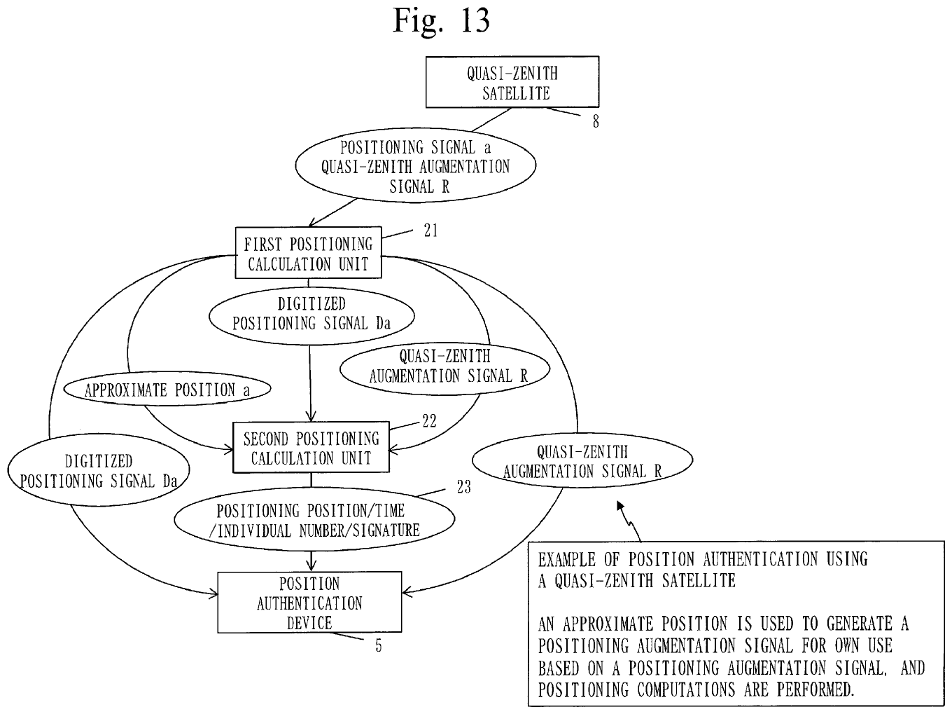

FIG. 13 is an explanatory diagram of a high-accuracy position authentication method in the position authentication system 1002.

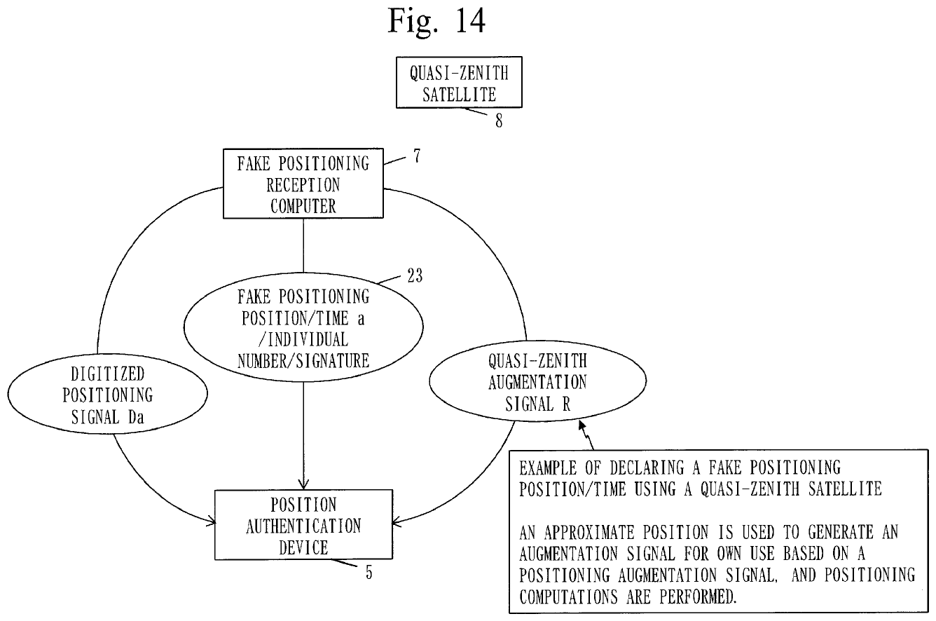

FIG. 14 is an explanatory diagram of Case 2 to be described later.

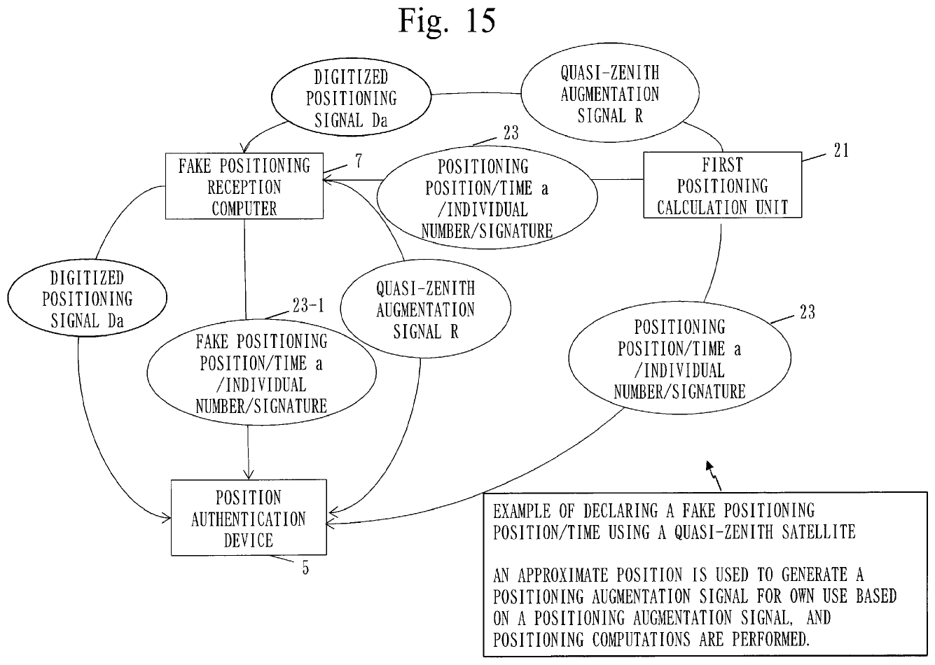

FIG. 15 is an explanatory diagram of Case 4 to be described later.

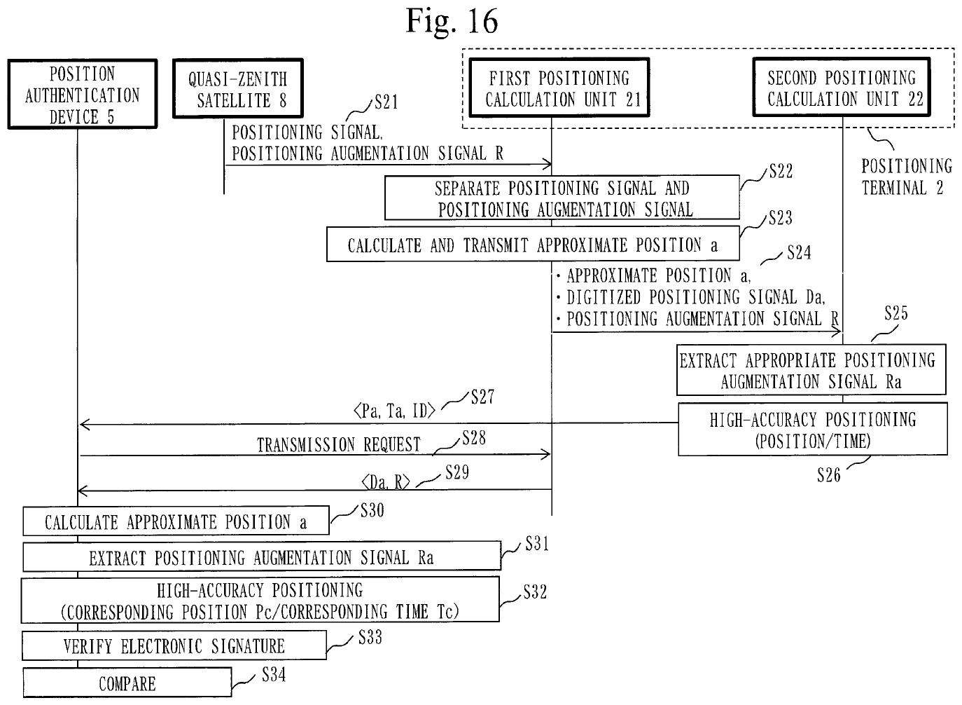

FIG. 16 is a sequence diagram that describes a position authentication method in the position authentication system 1002.

In the first embodiment, the positioning satellite 1 is used. In the second embodiment, the position authentication system 1002 using a quasi-zenith satellite 8 will be described. The position authentication system 1002 differs from the position authentication system 1001 in the following points.

(1) The position authentication system 1002 uses the quasi-zenith satellite 8.

(2) The position authentication system 1002 does not include a positioning augmentation signal generator 4, and a positioning augmentation signal is transmitted from the quasi-zenith satellite 8 as a quasi-zenith augmentation signal R to be described later.

FIGS. 12 and 13 describe the operation in a case where the quasi-zenith satellite 8 is used.

The high-accuracy position/time measurement method using a quasi-zenith augmentation signal in the position authentication system 1002 will be described with reference to FIGS. 12, 13, and 16. The quasi-zenith satellite 8 sends out a positioning signal and a quasi-zenith augmentation signal. The positioning signal sent out from the quasi-zenith satellite 8 is of a single type. However, depending on the position where this signal is received, the received positioning signal varies.

In the first positioning calculation unit 21, the positioning signal reception unit 21A uses the satellite signal reception device 250 to receive a positioning signal a and a quasi-zenith augmentation signal R that are sent out from the quasi-zenith satellite 8 (step S21). Here, the quasi-zenith augmentation signal R is a positioning augmentation signal R transmitted from the quasi-zenith satellite 8. The positioning terminal 2 receives the quasi-zenith augmentation signal R, which is a positioning augmentation signal, from the quasi-zenith satellite 8. In the first positioning calculation unit 21, the approximate position calculation unit 21C analyzes the received positioning signal a and quasi-zenith augmentation signal R to separate the positioning signal a and the quasi-zenith augmentation signal R (step S22). Then, the approximate position calculation unit 21C calculates an approximate position a based on the positioning signal a (step S23), and passes the approximate position a and the quasi-zenith augmentation signal R to the second positioning calculation unit 22. The digitized positioning signal transmission unit 21B digitizes the positioning signal a to generate a digitized positioning signal Da, and transmits the digitized positioning signal Da to the second positioning calculation unit 22 (step S24).

In the second positioning calculation unit 22, the position computation unit 22A obtains a positioning augmentation signal Ra appropriate for the approximate position a based on the approximate position a and the quasi-zenith augmentation signal R (step S25). The position computation unit 22A uses the positioning augmentation signal Ra at the approximate position a to calculate a positioning position Pa and a positioning time Ta that are highly accurate based on the digitized positioning signal Da (step S26).

The position authentication method of the position authentication system 1002 will be described with reference to FIGS. 13 and 16.

In the second positioning calculation unit 22, the terminal position information transmission unit 22B transmits terminal position information 23 to the position authentication device 5 (step S27). As in the first embodiment, the terminal position information 23 is transmitted to the position authentication device 5 together with an electronic signature. The authentication-side reception unit 51A uses the communication device 540 to receive the terminal position information 23.

The authentication-side digitized positioning signal reception unit 51B of the position authentication device 5 transmits a transmission request to request transmission of the digitized positioning signal Da and the quasi-zenith augmentation signal R to the first positioning calculation unit 21, using a communication channel not illustrated and via the communication device 540 (step S28). The digitized positioning signal transmission unit 21B of the first positioning calculation unit 21 receives the transmission request via the wireless communication device 240, and transmits the digitized positioning signal Da and the quasi-zenith augmentation signal R to the position authentication device 5 via the wireless communication device 240 (step S29). The authentication-side digitized positioning signal reception unit 51B receives the digitized positioning signal Da and the quasi-zenith augmentation signal R via the communication device 540. Note that when the transmission request for the digitized positioning signal Da and the quasi-zenith augmentation signal R is not transmitted to the position authentication device 5, and the terminal position information 23 is transmitted from the positioning terminal 2 to the position authentication device 5, the digitized positioning signal Da and the quasi-zenith augmentation signal R may also be transmitted.

The authentication-side comparison unit 51C of the position authentication device 5 uses the digitized positioning signal Da to calculate an approximate position a (step S30), and also obtains a positioning augmentation signal Ra appropriate for the approximate position a based on the approximate position a and the quasi-zenith augmentation signal R (step S31). Then, the authentication-side comparison unit 51C calculates a positioning position which is a corresponding position Pc of the positioning terminal 2 and a positioning time which is a corresponding time Tc, based on the digitized positioning signal Da and the positioning augmentation signal Ra at the approximate position a (step S32).

As in the first embodiment, the authentication-side comparison unit 51C verifies the electronic signature of the terminal position information 23 transmitted from the second positioning calculation unit 22 (step S33). If the verification is successful, the authentication-side comparison unit 51C authenticates that the terminal position information 23 is authentic and is the terminal position information 23 transmitted from the second positioning calculation unit 22 (positioning terminal 2) having the individual number. If the verification is unsuccessful, the authentication-side comparison unit 51C determines that the transmitted data is fraudulent.

Further, in the position authentication device 5, the authentication-side comparison unit 51C compares the positioning position Pa and the positioning time Ta included in the terminal position information 23 transmitted from the second positioning calculation unit 22 with the corresponding position Pc and the corresponding time Tc, as in the first embodiment (step S34). The authentication-side comparison unit 51C compares the positioning position Pa with the corresponding position Pc, and compares the positioning time Ta with the corresponding time Tc. If a difference between the positions and a difference between the times are less than or equal to a threshold for the difference between positions and a threshold for the difference between times, respectively, the authentication-side comparison unit 51C authenticates that the second positioning calculation unit 22 (positioning terminal 2) that transmits the terminal position information 23 is an authentic device. If the difference between the positioning positions or the positioning times exceeds the threshold, the authentication-side comparison unit 51C deems the second positioning calculation unit 22 (positioning terminal 2) that transmits the terminal position information 23 as fraudulent. For example, the threshold for the difference between positioning positions is assumed to be several centimeters.

Next, the reason why the position authentication system 1002 of the second embodiment enables position authentication will be described. In the second embodiment, since the quasi-zenith satellite 8 is used, no reference station is required. The second embodiment utilizes the fact that if a fraud occurs in the course of obtaining a positioning augmentation signal at an approximate position based on the approximate position and a quasi-zenith augmentation signal, the positioning augmentation signal at the approximate position will be inappropriate, resulting in a measurement result including a large error.

In the case of the second embodiment, when a position/time are fabricated, methods of Case 1 to Case 4 as described below may be considered.

Case 1. A position/time are fabricated without using a digitized positioning signal Da.

Case 2. Only a position/time are fabricated using a digitized positioning signal Da and a quasi-zenith augmentation signal R that have been previously used.

Case 3. Only a position/time are fabricated, although a correct digitized positioning signal Da and a correct quasi-zenith augmentation signal R are used.

Case 4. A first positioning terminal transfers a position/time calculated using a correct digitized positioning signal Da and a correct quasi-zenith augmentation signal R to a second positioning terminal. The second positioning terminal transmits the digitized positioning signal Da and the position/time to the position authentication device 5 from another location different from the location of the first positioning terminal, thereby fabricating the position/time of the second positioning terminal.

<Case 1>

Since a digitized positioning signal Da is not used, the positioning terminal cannot respond to the transmission request for the digitized positioning signal Da from the position authentication device 5 (step S28). Therefore, the position/time and the moving body terminal in this case are eliminated as fraudulent.

<Case 2>

FIG. 14 is a diagram illustrating Case 2 of the second embodiment. In Case 2, a digitized positioning signal Da previously used is transferred from the moving body terminal to the position authentication device 5, so that the position authentication device 5 calculates an approximate position a and obtains a positioning augmentation signal Ra at the approximate position a.

Then, a position/time of the moving body terminal are calculated. In Case 2, only the position/time are fabricated. This information is different from the position/time calculated by the position authentication device 5. Therefore, the position/time acquired from the fake positioning reception computer 7 and the moving body terminal which is the source of acquirement are eliminated as fraudulent.

<Case 3>

The position authentication device 5 uses a correct digitized positioning signal Da and a correct quasi-zenith augmentation signal R to calculate a position/time of the moving body terminal. This is different from fabricated position/time. Therefore, the fabricated position/time and the moving body terminal are eliminated as fraudulent.

<Case 4>

FIG. 15 is a diagram illustrating Case 4 of the second embodiment. In this case, correct positioning information (terminal position information 23), a correct quasi-zenith augmentation signal R, and the like that have been transferred are transmitted from a fabrication device (fake reception positioning computer 7), and the correct positioning information and the correct quasi-zenith augmentation signal which are the sources of the transferred ones are also transmitted from the authentic device. In Case 4, there are a plurality of existences of the moving body terminal that should be unique. Therefore, both are eliminated as fraudulent devices.

As described above, in the position authentication system 1002, the position authentication device 5 calculates the position/time of the moving body terminal based on the digitized positioning signal Da and the quasi-zenith augmentation signal R, and compares the calculated position/time with the position/time acquired from the positioning terminal. Therefore, the position authentication device 5 checks the integrity of the digitized positioning signal Da, the quasi-zenith augmentation signal R, and the position/time. As a result, this has the effect of eliminating a fraudulent position/time.

The position authentication device 5 verifies the electronic signature of a position/time/individual number (terminal position information 23). Therefore, in a case of fabrication where a correct position/time/individual number, a correct digitized positioning signal Da, and a correct quasi-zenith augmentation signal R are transferred and relayed, there are a plurality of existences of the valid position/time/individual number that should be unique. This has the effect of eliminating fraudulent position/time information.

Further, a signature is appended to a positioning position/time/individual number, and the position authentication device verifies the signature, so that the authentication and nonrepudiation of a transmission source are provided. This has the effect of eliminating a fraudulent device.

In the second embodiment, it has been described that the position authentication device 5 performs the authentication process each time a position/time/individual number are received. However, the position authentication device 5 may perform the authentication process at appropriate intervals.

Alternatively, the position authentication device 5 may perform the authentication process when the same positioning position/time/individual number are received a plurality of times.

In the position authentication system 1001 of the first embodiment and the position authentication system 1002 of the second embodiment described above, the position authentication device 5 acquires the data used by the position computation unit 22A to calculate the positioning position Pa and the positioning time Ta, and the position authentication device 5 uses the acquired data to perform the same calculations as that by the position computation unit 22A (positioning terminal 2). Therefore, according to the position authentication system 1001 of the first embodiment and the position authentication system 1002 of the second embodiment, fabrication of a position or a time can be eliminated in a system that provides service according to the position of a mobile terminal, so that secure service can be realized.

Note that the “service according to the position of the mobile terminal” includes, for example, a position navigation system, a disaster prevention information provision system, a disaster prevention information probe system, a traveling route charge setting system, and the like.

### REFERENCE SIGNS LIST

1: positioning satellite; 1001, 1002: position authentication system; 2: positioning terminal; 210: processor; 21: first positioning calculation unit; 21A: positioning signal reception unit; 21B: digitized positioning signal transmission unit; 21C: approximate position calculation unit; 22: second positioning calculation unit; 22A: position computation unit; 22B: terminal position information transmission unit; 23: terminal position information; 220: main memory; 230: auxiliary storage device; 240: wireless communication device; 250: satellite signal reception device; 3: electronic reference point; 4: positioning augmentation signal generator; 410: processor; 41A: positioning augmentation signal generation unit; 420: main memory; 430: auxiliary storage device; 440: communication device; 5: position authentication device; 510: processor; 51A: authentication-side reception unit; 51B: authentication-side digitized positioning signal reception unit; 51C: authentication-side comparison unit; 520: main memory; 530: auxiliary storage device; 540: communication device; 7: fake positioning reception computer; 8: quasi-zenith satellite; 9: position authentication system

1. A position authentication system comprising a positioning terminal device and a position authentication device,
wherein the positioning terminal device receives, from a positioning satellite that transmits a positioning signal, the positioning signal and calculates a positioning position which indicates a reception position of the positioning signal and a positioning time which indicates a time when the positioning terminal device exists at the positioning position, based on the received positioning signal, and transmits terminal position information including the positioning position, the positioning time, and identification information for identifying the positioning terminal device to the position authentication device, and
transmits a digitized positioning signal which is obtained by digitizing the positioning signal to the position authentication device, and
wherein the position authentication device calculates a corresponding position corresponding to the positioning position and a corresponding time corresponding to the positioning time, based on the digitized positioning signal transmitted from the positioning terminal device, and compares the corresponding position with the positioning position and compares the corresponding time with the positioning time.

2. The position authentication system according to claim 1,
wherein the positioning terminal device calculates the positioning position and the positioning time, based on a positioning augmentation signal for correcting a calculation error of the positioning position in addition to the positioning signal, and
wherein the position authentication device acquires the positioning augmentation signal, and calculates the corresponding position and the corresponding time, based on the acquired positioning augmentation signal in addition to the digitized positioning signal.

3. The position authentication system according to claim 1,
wherein when transmitting the terminal position information, the positioning terminal device applies an electronic signature to the terminal position information, and transmits the terminal position information to which the electronic signature has been applied to the position authentication device, and
wherein upon receiving the terminal position information to which the electronic signature has been applied, the position authentication device verifies the electronic signature.

4. The position authentication system according to claim 2,
wherein the positioning terminal device receives the positioning augmentation signal from a quasi-zenith satellite, and
wherein the position authentication device acquires the positioning augmentation signal by receiving the positioning augmentation signal from the positioning terminal device.

5. A positioning terminal device that receives, from a positioning satellite that transmits a positioning signal, the positioning signal and performs positioning, the positioning terminal device comprising:
processing circuitry to:
receive the positioning signal from the positioning satellite;
calculate a positioning position which indicates a reception position of the positioning signal and a positioning time which indicates a time when the positioning terminal device exists at the positioning position, based on the received positioning signal; and
transmit terminal position information including the positioning position, the positioning time, and identification information for identifying the positioning terminal device to a position authentication device; and
transmit a digitized positioning signal which is obtained by digitizing the positioning signal to the position authentication device.

6. A position authentication device comprising:
processing circuitry to:
receive terminal position information from a positioning terminal device that receives, from a positioning satellite that transmits a positioning signal, the positioning signal and calculates a positioning position which indicates a reception position of the positioning signal, based on the positioning signal, the terminal position information including the positioning position, a positioning time which indicates a time when the positioning terminal device exists at the positioning position, and identification information for identifying the positioning terminal device;
receive, from the positioning terminal device, a digitized positioning signal which is obtained by digitizing the positioning signal by the positioning terminal device; and
calculate a corresponding position corresponding to the positioning position and a corresponding time corresponding to the positioning time, based on the digitized positioning signal, and compare the corresponding position with the positioning position and compare the corresponding time with the positioning time.

7. The position authentication device according to claim 6,
wherein the positioning terminal device calculates the positioning position and the positioning time, based on a positioning augmentation signal for correcting a calculation error of the positioning position in addition to the positioning signal, and
wherein the processing circuitry acquires the positioning augmentation signal, and calculates the corresponding position and the corresponding time, based on the acquired positioning augmentation signal in addition to the digitized positioning signal.

8. The position authentication device according to claim 7,
wherein the positioning terminal device receives the positioning augmentation signal from a quasi-zenith satellite, and
wherein the position authentication device acquires the positioning augmentation signal by receiving the positioning augmentation signal from the positioning terminal device.

9. The position authentication system according to claim 2,
wherein when transmitting the terminal position information, the positioning terminal device applies an electronic signature to the terminal position information, and transmits the terminal position information to which the electronic signature has been applied to the position authentication device, and
wherein upon receiving the terminal position information to which the electronic signature has been applied, the position authentication device verifies the electronic signature.
